(19) United States
(12) Patent Application Publication
(10) Pub. No.: US 2011/0117337 A1
(43) Pub. Date: May 19, 2011

(54) Magenta Dyes and Inks for Use in Ink-Jet Printing

(75) Inventors: Gavin Wright, Manchester (GB); Toshiki Fujiwara, Kanagawa (JP)

(73) Assignees: FUJIFILM IMAGING COLORANTS LIMITED, Manchester (GB); FUJIFILM CORPORATION, Tokyo (JP)

(21) Appl. No.: 13/002,755

(22) PCT Filed: Jun. 24, 2009
(86) PCT No.: PCT/GB2009/050723

§ 371 Date: Jan. 5, 2011

(30) Foreign Application Priority Data
Jul. 11, 2008 (GB) 0812721.9

(51) Int. Cl. B32B 3/10; C09B 29/36; C09B 29/46; C09D 11/02; B41J 2/175

(52) U.S. Cl. 428/211.1; 534/731; 106/31.13; 428/195.1; 347/20; 347/100; 347/86

(57) ABSTRACT

A compound of Formula (1) and salts thereof:

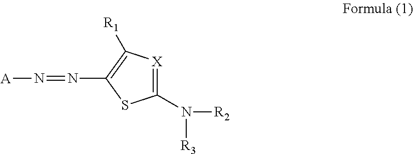

wherein:
A is optionally substituted heterocyclyl;
X is N or C—CN;
R¹ is H or a substituent;
R² and R³ are independently H, optionally substituted alkyl, optionally substituted aryl, optionally substituted heterocyclyl or —SO₂R⁴, wherein R⁴ is optionally substituted optionally substituted aryl or optionally substituted heterocyclyl; and
   provided that the compound of Formula (1) has attached, either directly or through a substituent, at least one ionic water solubilising group selected from the group consisting of CO₂H, COSH, SO₃H and PO₃H₂. Also compositions, inks, ink-jet printing processes, printed materials and ink-jet cartridges.

This invention relates to dyes, to compositions and inks for ink-jet printers, to printing processes, to printed substrates and to ink-jet printer cartridges.

Ink-jet printing is a non-impact printing technique in which droplets of ink are ejected through a fine nozzle onto a substrate without bringing the nozzle into contact with the substrate. The inkjet used in this technique typically comprise yellow, magenta, cyan and black inks.

With the advent of high-resolution digital cameras and ink-jet printers it is becoming increasingly common to print off photographs using an ink-jet printer.

While ink-jet printers have many advantages over other forms of printing and image development there are still technical challenges to be addressed. For example, there are the contradictory requirements of providing ink colorants that are soluble in the ink medium and yet display excellent wet-fastness (i.e. prints do not run or smudge when printed). The inks also need to dry quickly to avoid sheets sticking together after they have been printed, but they should not form a crust over the tiny nozzles in the printer head. When printed the colorants and inks should also be resistant to smear when a highlighter pen is run over a print. Storage stability is important to avoid particle formation that could block the tiny nozzles used in the printer especially since consumers can keep an ink-jet ink cartridge for several months. Furthermore, and especially important with photographic quality reproductions, the resultant images should not bronze or fade excessively on exposure to light or common oxidising gases such as ozone. It is also important that the shade and chroma of the colorant are exactly right so that any image may be optimally reproduced.

Thus developing new colorants for ink-jet printing presents a unique challenge in balancing all these conflicting and demanding properties.

The present invention provides a compound of Formula (1) and salts thereof:

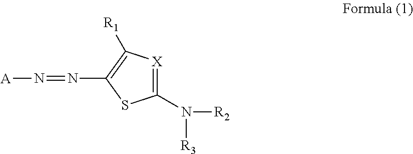

wherein:
A is optionally substituted heterocyclyl;
X is N or C—CN;
R¹ is H or a substituent;
R² and R³ are independently H, optionally substituted alkyl, optionally substituted aryl, optionally substituted heterocyclyl or —SO₂R⁴, wherein R⁴ is optionally substituted alkyl, optionally substituted aryl or optionally substituted heterocyclyl; and
   provided that the compound of Formula (1) has attached, either directly or through a substituent, at least one ionic water solubilising group selected from the group consisting of CO₂H, COSH, SO₃H and PO₃H₂.

Preferably A is an optionally substituted heteroaryl group. More preferably A is selected from the group consisting of: optionally substituted pyrrolyl, optionally substituted benzothiazole, optionally substituted pyrazolyl, optionally substituted imidazolyl, optionally substituted triazolyl, optionally substituted thiazolyl, optionally substituted thiadiazolyl, optionally substituted pyridyl, optionally substituted pyrimidyl, optionally substituted pyrazinyl and optionally substituted isothiazolyl. It is especially preferred that A is optionally substituted pyrazolyl, optionally substituted thiazolyl, optionally substituted thiadiazolyl or optionally substituted isothiazolyl. More especially it is preferred that A is optionally substituted pyrazolyl or optionally substituted isothiazolyl.

Preferably X is N.

Preferably R¹ is selected from the group consisting of optionally substituted alkyl (preferably C₁₋₄-alkyl), optionally substituted alkenyl (preferably C₁₋₄-alkenyl), optionally substituted alkynyl (preferably C₁₋₄-alkynyl), optionally substituted alkoxy (preferably C₁₋₄-alkoxy), optionally substituted aryl (especially optionally substituted phenyl), optionally substituted heterocyclyl (especially optionally substituted pyrrolyl, optionally substituted furyl, optionally substituted thienyl, optionally substituted pyrazolyl, optionally substituted imidazolyl, optionally substituted triazolyl, optionally substituted thiazolyl, optionally substituted thiadiazolyl, optionally substituted pyridyl, optionally substituted pyrimidyl, optionally substituted pyrazinyl and optionally substituted isothiazolyl), optionally substituted aryloxy (preferably phenoxy), polyalkylene oxide (preferably polyethylene oxide or polypropylene oxide), CO₂H, SO₃H, PO₃H₂, nitro, cyano, halo, ureido, —SO₂F, hydroxy, ester, sulphate, —NR^{a}R^{b}, —COR^{a}, —CONR^{a}R^{b}, —NHCOR^{a}, carboxyester, sulfone, and —SO₂NR^{a}R^{b} wherein R^{a} and R^{b} are each independently H, optionally substituted alkyl (especially C₁₋₄-alkyl), —S—R^{b}, —O—R^{c}, —NH—R^{c}, wherein R^{c} is optionally substituted alkyl (preferably C₁₋₄-alkyl), optionally substituted alkenyl (preferably C₁₋₄-alkenyl), optionally substituted alkynyl (preferably C₁₋₄-alkynyl), optionally substituted alkoxy (preferably C₁₋₄-alkoxy), optionally substituted aryl (preferably phenyl), optionally substituted aryloxy (preferably phenoxy), optionally substituted heterocyclyl, polyalkylene oxide (preferably polyethylene oxide or polypropylene oxide), optional substituents for any of the above substituents may be selected from the same list of substituents.

It is especially preferred that R¹ is H, optionally substituted alkyl (especially optionally substituted C₁₋₄-alkyl), optionally substituted aryl (especially optionally substituted phenyl) or optionally substituted heterocyclyl (especially optionally substituted pyridyl or thienyl).

R⁴, R² and R³, when they are optionally substituted alkyl, independently, may be linear branched or cyclic optionally substituted alkyl groups. Preferably R⁴, R² and R³ are linear or branched optionally substituted alkyl groups. It is particularly preferred that R⁴, R² and R³ are each independently optionally substituted C₁₋₁₂-alkyl and more particularly preferred that R⁴, R² and R³ are each independently optionally substituted C₁₋₈-alkyl, especially optionally substituted C₁₋₄-alkyl.

R⁴, R² and R³ when they are optionally substituted aryl, independently, are preferably optionally substituted phenyl or optionally substituted napthyl, more preferably they are independently optionally substituted phenyl.

When R⁴, R² and R³ are optionally substituted heterocyclyl they are preferably, independently, selected from the group consisting of the following: optionally substituted triazinyl, pyrrolyl, optionally substituted furyl, optionally substituted thienyl, optionally substituted pyrazolyl, optionally substituted imidazolyl, optionally substituted triazolyl, optionally substituted thiazolyl, optionally substituted thiadiazolyl, optionally substituted pyridyl, optionally substituted pyrimidyl, optionally substituted pyrazinyl and optionally substituted isothiazolyl.

Preferably R² and R³ independently are: H; optionally substituted alkyl, especially optionally substituted C₁₋₄-alkyl and more especially optionally substituted C₁₋₄-alkyl carrying an ionic water solubilising group selected from the group consisting of CO₂H, COSH, SO₃H and PO₃H₂; optionally substituted phenyl and more especially optionally substituted phenyl carrying an ionic water solubilising group selected from the group consisting of CO₂H, COSH, SO₃H and PO₃H₂.

Preferably one of R² and R³ is not H.

Preferably R⁴ is optionally substituted phenyl.

The compulsory ionic water solubilising group may be bound either directly to the compound of Formula (1) or indirectly via a substituent group. When there is more than one ionic water solubilising group attached to the compound of Formula (1) then the ionic water solubilising group may be either the same or different. Preferably the compulsory ionic water solubilising group is CO₂H or SO₃H.

Optional substituents present on the groups described herein are preferably independently selected from: optionally substituted alkyl (preferably C₁₋₄-alkyl), (except where the group to be optionally substituted is alkyl), optionally substituted alkenyl (preferably C₁₋₄-alkenyl), optionally substituted alkynyl (preferably C₁₋₄-alkynyl), optionally substituted alkoxy (preferably C₁₋₄-alkoxy), optionally substituted aryl (preferably phenyl), optionally substituted aryloxy (preferably phenoxy), optionally substituted heterocyclyl (including heteroaryl), polyalkylene oxide (preferably polyethylene oxide or polypropylene oxide), CO₂H, SO₃H, PO₃H₂, nitro, cyano, halo, ureido, —SO₂F, hydroxy, ester, sulphate, —NR^{a}R^{b}, —COR^{a}, —CONR^{a}R^{b}, —NHCOR^{a}, carboxyester, sulfone, and —SO₂NR^{a}R^{b} wherein R^{a} and R^{b} are each independently H, optionally substituted alkyl (especially C₁₋₄-alkyl), —S—R^{c}, —O—R^{c}, —NH—R^{c}, wherein R^{c} is optionally substituted alkyl (preferably C₁₋₄-alkyl), optionally substituted alkenyl (preferably C₁₋₄-alkenyl), optionally substituted alkynyl (preferably C₁₋₄-alkynyl), optionally substituted alkoxy (preferably C₁₋₄-alkoxy), optionally substituted aryl (preferably phenyl), optionally substituted aryloxy (preferably phenoxy), optionally substituted heterocyclyl, polyalkylene oxide (preferably polyethylene oxide or polypropylene oxide), optional substituents for any of the above substituents may be selected from the same list of substituents.

Preferred substituents on A are optionally substituted alkyl (especially optionally substituted C₁₋₄-alkyl), optionally substituted aryl (especially optionally substituted phenyl), cyano, SO2R4, nitro, CF3, CO₂H, SO₃H and PO₃H₂

The compounds of Formula (1) are also preferably free from fibre reactive groups. The term fibre reactive group is well known in the art and is described for example in EP 0356014 A1. Fibre reactive groups are capable, under suitable conditions, of reacting with the hydroxyl groups present in cellulosic fibres or with the amino groups present in natural fibres to form a covalent linkage between the fibre and the dye. As examples of fibre reactive groups excluded from the compounds of Formula (1) there may be mentioned aliphatic sulfonyl groups which contain a sulfate ester group in beta-position to the sulfur atom, e.g. beta-sulfato-ethylsulfonyl groups, alpha, beta-unsaturated acyl radicals of aliphatic carboxylic acids, for example acrylic acid, alpha-chloro-acrylic acid, alpha-bromoacrylic acid, propiolic acid, maleic acid and mono- and dichloro maleic; also the acyl radicals of acids which contain a substituent which reacts with cellulose in the presence of an alkali, e.g. the radical of a halogenated aliphatic acid such as chloroacetic acid, beta-chloro and beta-bromopropionic acids and alpha, beta-dichloro- and dibromopropionic acids or radicals of vinylsulfonyl- or beta-chloroethylsulfonyl- or beta-sulfatoethyl-sulfonyl-endo-methylene cyclohexane carboxylic acids. Other examples of cellulose reactive groups are tetrafluorocyclobutyl carbonyl, trifluoro-cyclobutenyl carbonyl, tetrafluorocyclobutylethenyl carbonyl, trifluoro-cyclobutenylethenyl carbonyl; activated halogenated 1,3-dicyanobenzene radicals; and heterocyclic radicals which contain 1, 2 or 3 nitrogen atoms in the heterocyclic ring and at least one cellulose reactive substituent on a carbon atom of the ring, for example a triazinyl halide.

Acid and basic groups on the compounds of Formula (1), particularly acid groups, are preferably in the form of a salt. Thus, the Formulae shown herein include the compounds in free acid and in salt form.

Preferred salts are alkali metal salts, especially lithium, sodium and potassium, ammonium and substituted ammonium salts (including quaternary amines such as ((CH₃)₄N⁺) and mixtures thereof. Especially preferred are salts with sodium, lithium, ammonia and volatile amines, more especially sodium salts.

The compounds of Formula (1) may be converted into a salt using known techniques.

The compounds of Formula (1) may exist in tautomeric forms other than those shown in this specification. These tautomers are included within the scope of the present invention.

The compounds of Formula (1) may be prepared using conventional synthetic processes, for example by diazotizing an amine of Formula (2):

A-NH₂ Formula (2)

where A is as defined above and coupling the resultant diazonium salt with a compound of Formula (3):

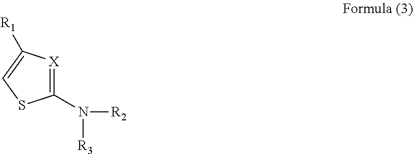

wherein X, R¹, R² and R³ are as defined above. Compounds of Formula (2) and Formula (3) are either commercially available or may be easily prepared from commercially available starting materials using known processes.

The compounds of Formula (1) have attractive, strong red, violet and magenta shades (especially magenta) and are valuable colorants for use in the preparation of ink-jet printing inks. They benefit from a good balance of solubility, storage stability and fastness to water, ozone and light.

According to a second aspect of the present invention there is provided a composition comprising a compound of Formula (1) and/or a salt thereof, as described in the first aspect of the invention, and a liquid medium.

Preferred compositions according to the second aspect of the invention comprise:
(a) from 0.01 to 30 parts of a compound of Formula (1) and salts thereof according to the first aspect of the invention; and
(b) from 70 to 99.99 parts of a liquid medium;
   wherein all parts are by weight.

Preferably the number of parts of (a)+(b)=100.

The number of parts of component (a) is preferably from 0.1 to 20, more preferably from 0.5 to 15, and especially from 1 to 5 parts. The number of parts of component (b) is preferably from 80 to 99.9, more preferably from 85 to 99.5 and especially from 95 to 99 parts.

Preferably component (a) is completely dissolved in component (b). Preferably component (a) has a solubility in component (b) at 20° C. of at least 10%. This allows the preparation of liquid dye concentrates that may be used to prepare more dilute inks and reduces the chance of the dye precipitating if evaporation of the liquid medium occurs during storage.

The inks may be incorporated in an ink-jet printer as a high concentration magenta ink, a low concentration magenta ink or both a high concentration and a low concentration ink. In the latter case this can lead to improvements in the resolution and quality of printed images. Thus the present invention also provides a composition (preferably an ink) where component (a) is present in an amount of 2.5 to 7 parts, more preferably 2.5 to 5 parts (a high concentration ink) or component (a) is present in an amount of 0.5 to 2.4 parts, more preferably 0.5 to 1.5 parts (a low concentration ink).

Preferred liquid media include water, a mixture of water and organic solvent and organic solvent free from water. Preferably the liquid medium comprises a mixture of water and organic solvent or organic solvent free from water.

When the liquid medium (b) comprises a mixture of water and organic solvent, the weight ratio of water to organic solvent is preferably from 99:1 to 1:99, more preferably from 99:1 to 50:50 and especially from 95:5 to 80:20.

It is preferred that the organic solvent present in the mixture of water and organic solvent is a water-miscible organic solvent or a mixture of such solvents. Preferred water-miscible organic solvents include C₁₋₆-alkanols, preferably methanol, ethanol, n-propanol, isopropanol, n-butanol, sec-butanol, tert-butanol, n-pentanol, cyclopentanol and cyclohexanol; linear amides, preferably dimethylformamide or dimethylacetamide; ketones and ketone-alcohols, preferably acetone, methyl ether ketone, cyclohexanone and diacetone alcohol; water-miscible ethers, preferably tetrahydrofuran and dioxane; diols, preferably diols having from 2 to 12 carbon atoms, for example ethylene glycol, propylene glycol, butylene glycol, pentylene glycol, hexylene glycol and thiodiglycol and oligo- and poly-alkyleneglycols, preferably diethylene glycol, triethylene glycol, polyethylene glycol and polypropylene glycol; triols, preferably glycerol and 1,2,6-hexanetriol; mono-C₁₋₄-alkyl ethers of diols, preferably mono-C₁₋₄-alkyl ethers of diols having 2 to 12 carbon atoms, especially 2-methoxyethanol, 2-(2-methoxyethoxy)ethanol, 2-(2-ethoxyethoxy)-ethanol, 2-[2-(2-methoxyethoxy)ethoxy]ethanol, 2-[2-(2-ethoxyethoxy)-ethoxy]-ethanol and ethyleneglycol monoallylether; cyclic amides, preferably 2-pyrrolidone, N-methyl-2-pyrrolidone, N-ethyl-2-pyrrolidone, caprolactam and 1,3-dimethylimidazolidone; cyclic esters, preferably caprolactone; sulfoxides, preferably dimethyl sulfoxide; and sulfones, preferably sulfolane. Preferably the liquid medium comprises water and 2 or more, especially from 2 to 8, water-miscible organic solvents.

Especially preferred water-miscible organic solvents are cyclic amides, especially 2-pyrrolidone, N-methyl-pyrrolidone and N-ethyl-pyrrolidone; diols, especially 1,5-pentane diol, ethyleneglycol, thiodiglycol, diethyleneglycol and triethyleneglycol; and mono-C₁₋₄-alkyl and C₁₋₄-alkyl ethers of diols, more preferably mono-C₁₋₄-alkyl ethers of diols having 2 to 12 carbon atoms.

When the liquid medium comprises organic solvent free from water, (i.e. less than 1% water by weight) the solvent preferably has a boiling point of from 30 to 200° C., more preferably of from 40 to 150° C., especially from 50 to 125° C. The organic solvent may be water-immiscible, water-miscible or a mixture of such solvents. Preferred water-miscible organic solvents are any of the hereinbefore-described water-miscible organic solvents and mixtures thereof. Preferred water-immiscible solvents include, for example, aliphatic hydrocarbons; esters, preferably ethyl acetate; chlorinated hydrocarbons, preferably CH₂Cl₂; and ethers, preferably diethyl ether; and mixtures thereof.

When the liquid medium comprises a water-immiscible organic solvent, preferably a polar solvent is included because this enhances solubility of the dyes in the liquid medium. Examples of polar solvents include C₁₋₄-alcohols.

In view of the foregoing preferences it is especially preferred that where the liquid medium is organic solvent free from water it comprises a ketone (especially methyl ethyl ketone) and/or an alcohol (especially a C₁₋₄-alkanol, more especially ethanol or propanol).

The organic solvent free from water may be a single organic solvent or a mixture of two or more organic solvents. It is preferred that when the liquid medium is organic solvent free from water it is a mixture of 2 to 5 different organic solvents. This allows a liquid medium to be selected that gives good control over the drying characteristics and storage stability of the ink.

Liquid media comprising organic solvent free from water are particularly useful where fast drying times are required and particularly when printing onto hydrophobic and non-absorbent substrates, for example plastics, metal and glass.

The liquid media may of course contain additional components conventionally used in ink-jet printing inks, for example viscosity and surface tension modifiers, corrosion inhibitors, biocides, kogation reducing additives and surfactants which may be ionic or non-ionic.

Although not usually necessary, further colorants may be added to the ink to modify the shade and performance properties.

It is preferred that the composition according to the invention is ink suitable for use in an ink-jet printer. Ink suitable for use in an ink-jet printer is ink which is able to repeatedly fire through an ink-jet printing head without causing blockage of the fine nozzles. To do this the ink must be particle free, stable (i.e. not precipitate on storage), free from corrosive elements (e.g. chloride) and have a viscosity which allows for good droplet formation at the print head.

Ink suitable for use in an ink-jet printer preferably has a viscosity of less than 20 cP, more preferably less than 10 cP, especially less than 5cP, at 25° C.

Ink suitable for use in an ink-jet printer preferably contains less than 500 ppm, more preferably less than 250 ppm, especially less than 100 ppm, more especially less than 10 ppm in total of divalent and trivalent metal ions (other than any divalent and trivalent metal ions bound to a colorant of Formula (1) or any other colourant or additive incorporated in the ink).

Preferably ink suitable for use in an ink-jet printer has been filtered through a filter having a mean pore size below 10 μm, more preferably below 3 μm, especially below 2 μm, more especially below 1 μm. This filtration removes particulate matter that could otherwise block the fine nozzles found in many ink-jet printers.

Preferably ink suitable for use in an ink-jet printer contains less than 500 ppm, more preferably less than 250 ppm, especially less than 100 ppm, more especially less than 10 ppm in total of halide ions.

A third aspect of the invention provides a process for forming an image on a substrate comprising applying a composition, preferably ink suitable for use in an ink-jet printer, according to the second aspect of the invention, thereto by means of an ink-jet printer.

The ink-jet printer preferably applies the ink to the substrate in the form of droplets that are ejected through a small orifice onto the substrate. Preferred ink-jet printers are piezoelectric ink-jet printers and thermal ink-jet printers. In thermal ink-jet printers, programmed pulses of heat are applied to the ink in a reservoir by means of a resistor adjacent to the orifice, thereby causing the ink to be ejected from the orifice in the form of small droplets directed towards the substrate during relative movement between the substrate and the orifice. In piezoelectric ink-jet printers the oscillation of a small crystal causes ejection of the ink from the orifice. Alternately the ink can be ejected by an electromechanical actuator connected to a moveable paddle or plunger, for example as described in International Patent Application WO00/48938 and International Patent Application WO00/55089.

The substrate is preferably paper, plastic, a textile, metal or glass, more preferably paper, an overhead projector slide or a textile material, especially paper.

Preferred papers are plain or treated papers which may have an acid, alkaline or neutral character. Glossy papers are especially preferred. Photographic quality papers are especially preferred. Photographic quality paper are high-gloss papers which give a similar finish to that typically seen with silver halide photo printing.

A fourth aspect of the present invention provides a material preferably paper, plastic, a textile, metal or glass, more preferably paper, an overhead projector slide or a textile material, especially paper more especially plain, coated or treated papers printed with a compound as described in the first aspect of the invention, a composition according to the second aspect of the invention or by means of a process according to the third aspect of the invention.

It is especially preferred that the printed material of the fourth aspect of the invention is a print on a photographic quality paper.

A fifth aspect of the present invention provides an ink-jet printer cartridge comprising a chamber and a composition, preferably ink suitable for use in an ink-jet printer, wherein the composition is in the chamber and the composition is as defined and preferred in the second aspect of the present invention. The cartridge may contain a high concentration ink and a low concentration ink, as described in the second aspect of the invention, in different chambers.

The invention is further illustrated by the following Examples in which all parts and percentages are by weight unless otherwise stated.

### EXAMPLE 1

### Preparation of

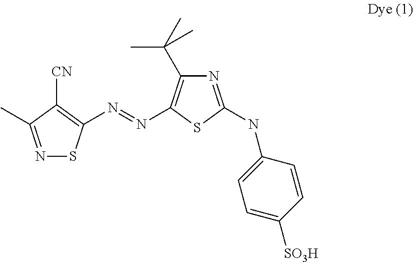

### Stage (a)

### Preparation of Intermediate (1a):

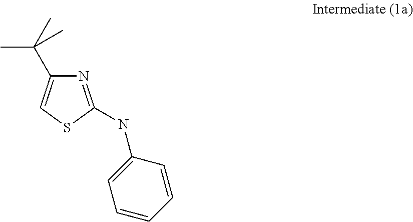

1-Bromo-3,3-dimethylbutan-2-one (39.4 g, 0.20 mol) was added to a mixture of N-phenylhiourea (30.4 g, 0.20 mol), water (800 ml) and ethanol (100 ml). The reaction mixture was stirred at reflux for 2 hours before allowing to cool to 20° C. Sodium hydrogencarbonate was then added to the reaction mixture to adjust the pH to 8 and the crude product was collected by filtration. The collected solid was washed with water (500 ml), recrystallised from aqueous ethanol and dried to give 36.8 g (79%) of a cream solid.

### Stage (b)

### Preparation of Intermediate (1b):

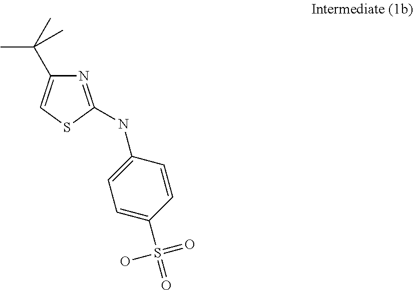

The product from stage (a) above (2 g, 86 mmol) was added in portions to 15% oleum (15 ml) at 15° C. The reaction mixture was stirred at 15-20° C. for 1 hour and then added slowly to diethyl ether (400 ml) at 10° C. The diethyl ether was decanted from the crude product which was dried in a vacuum desiccator and used in the next stage without further purification.

### Stage (c)

### Preparation of the Title Product:

Nitrosyl sulfuric acid (2.83 g, 9 mmol) was added dropwise to a mixture of orthophosphoric acid (15 g, 130 mmol) and glacial acetic acid (2.69 g, 45 mmol) at −10° C. A solution of 5-amino-3-methylisothiazole-4-carbonitrile prepared according to the method described in GB2335924 (1.2 g, 9 mmol) in DMSO (5 ml) was then added dropwise to the reaction mixture which was kept at −10° C. The reaction mixture was stirred at −10° C. for 2 hours before adding slowly to a solution of the product from stage (b) in water (200 ml) at −5° C. When addition of the diazonium solution was complete the pH of the reaction mixture was raised to 5 with sodium acetate and the reaction mixture was stirred for 16 hours and allowed to warm to room temperature. The crude product was collected by filtration and dissolved in water (200 ml) at pH 9, adjusted by the addition of 2N sodium hydroxide solution. The solution of the crude product was dialysed to low conductivity and dried at 60° C. to give 500 mg of a dark red solid.

### EXAMPLES 2 TO 30

Prepared by analogous processes to those described for Example 1. In the table below * indicates the point of attachment.

| Ex | A | R1 | X | R2 | R3 |
|---|---|---|---|---|---|
| 2 | 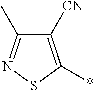 | t-Butyl | N | 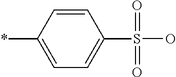 | 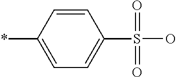 |
| 3 | 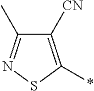 | 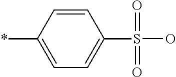 | N | Me | Me |
| 4 | 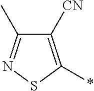 | 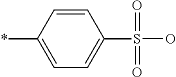 | N | H | H |
| 5 | 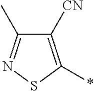 | 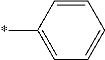 | N | H | 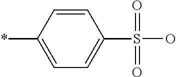 |
| 6 | 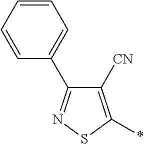 | t-Butyl | N | H | 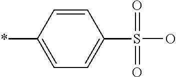 |
| 7 | 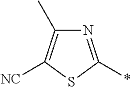 | t-Butyl | N | 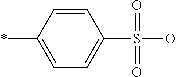 | 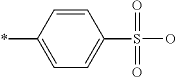 |
| 8 | 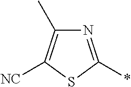 | t-Butyl | N | 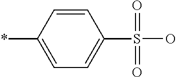 | H |
| 9 | 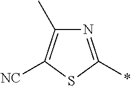 | 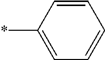 | N | 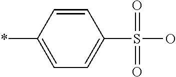 | H |
| 10 | 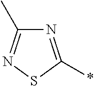 | t-Butyl | N | 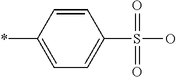 | H |
| 11 | 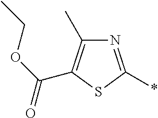 | t-Butyl | N | 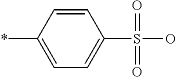 | H |
| 12 | 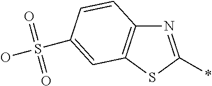 | t-Butyl | N | 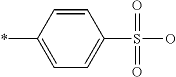 | H |
| 13 | 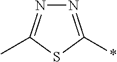 | t-Butyl | N | 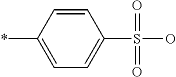 | H |
| 14 | 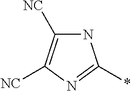 | t-Butyl | N | 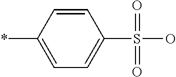 | H |
| 15 | 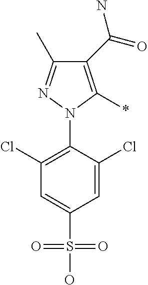 | t-Butyl | N | 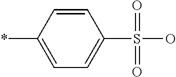 | H |
| 16 | 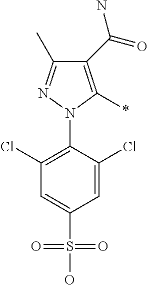 | t-Butyl | N | i-propyl | i-propyl |
| 17 | 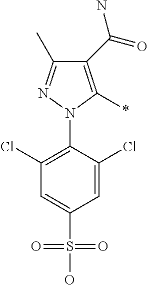 | t-Butyl | N | 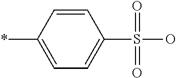 | 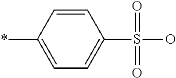 |
| 18 | 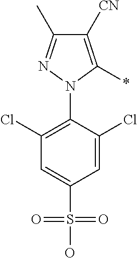 | t-Butyl | N | 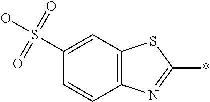 | H |
| 19 | 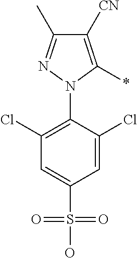 | t-Butyl | N | 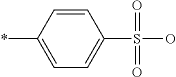 | Me |
| 20 | 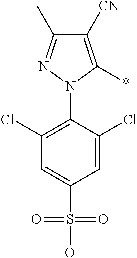 | t-Butyl | N | Me | Me |
| 21 | 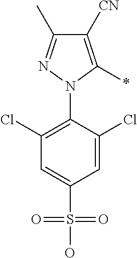 | t-Butyl | N | 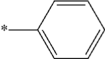 | Me |
| 22 | 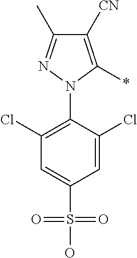 | t-Butyl | N | 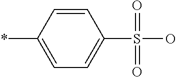 | 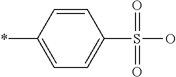 |
| 23 | 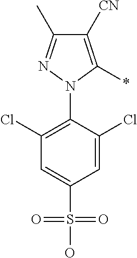 | t-Butyl | N | i-propyl | i-propyl |
| 24 | 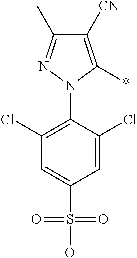 | t-Butyl | N | 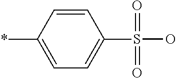 | H |
| 25 | 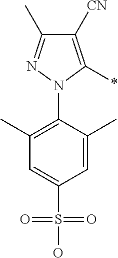 | t-Butyl | N | 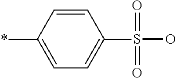 | H |
| 26 | 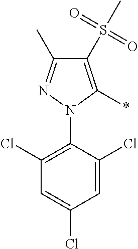 | t-Butyl | N | 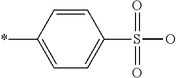 | 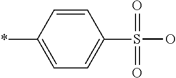 |
| 27 | 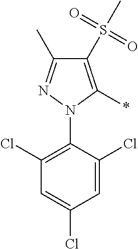 | t-Butyl | N | 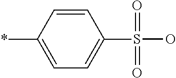 | H |
| 28 | 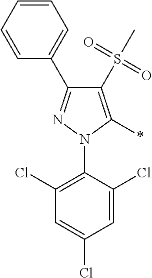 | t-Butyl | N | 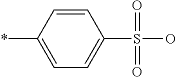 | H |
| 29 | 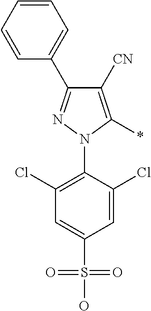 | t-Butyl | N | 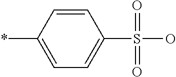 | H |
| 30 | 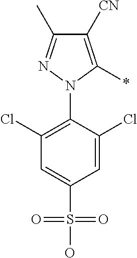 | 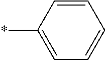 | N | 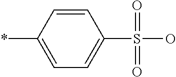 | H |

### EXAMPLE 31

### Preparation of Inks

An ink was prepared by dissolving 3.5 g of the dye of Example 1 in 96.5 g of a liquid medium comprising:

| | | |
|---|---|---|
| Diethylene glycol | 7% | |
| Ethylene glycol | 7% | |
| 2-Pyrollidone | 7% | |
| Surfynol ™ 465 | 1% | |
| Tris buffer | 0.2% | |
| Water | 77.8% | (all % by weight) |

and adjusting the pH of the ink to 8-8.5 using sodium hydroxide.

Surfynol® 465 is a surfactant from Air Products.

### EXAMPLE 32

### Ink-Jet Printing

The Example Ink, prepared as described above, was filtered through a 0.45 micron nylon filter and then incorporated into empty print cartridges using a syringe.

This was then printed on to the following ink-jet media at 50% depth;

Epson Ultra Premium Glossy Photo Paper (SEC PM); and

Canon Premium PR101Photo Paper (PR101)

HP Advanced Photo Paper (HPP).

### Further Inks

The inks described in Tables A and B may be prepared using the compound of Example 1. The dye indicated in the first column is dissolved in 100 parts of the ink as specified in the second column on. Numbers quoted in the second column onwards refer to the number of parts of the relevant ink ingredient and all parts are by weight. The pH of the ink may be adjusted using a suitable acid or base. The inks may be applied to a substrate by ink-jet printing.

The following abbreviations are used in Tables A and B:

PG=propylene glycol

DEG=diethylene glycol

NMP=N-methylpyrrolidone

DMK=dimethylketone

IPA=isopropanol

2P=2-pyrrolidone

MIBK=methylisobutyl ketone

P12=propane-1,2-diol

BDL=butane-2,3-diol

TBT=tertiary butanol

TDG=thiodiglycol

TABLE A

| Dye | Water | PG | DEG | NMP | DMK | IPA | 2P | MIBK |
|---|---|---|---|---|---|---|---|---|
| 2.0 | 80 | 5 | | 6 | 4 | | 5 | |
| 3.0 | 90 | | 5 | 5 | | | | |
| 10.0 | 85 | 3 | | 3 | 3 | | 6 | |
| 2.1 | 91 | | 8 | | | | | 1 |
| 3.1 | 86 | 5 | | | | 4 | | 5 |
| 1.1 | 81 | | | 9 | | | 10 | |
| 2.5 | 60 | 4 | 15 | 3 | 3 | 6 | 5 | 4 |
| 5 | 65 | | 20 | | | 10 | 5 | |
| 2.4 | 75 | 5 | 10 | | 5 | | | 5 |
| 4.1 | 80 | 3 | 5 | 2 | 10 | | | |
| 3.2 | 65 | | 5 | 4 | 6 | 5 | 10 | 5 |
| 5.1 | 96 | | | | | | 4 | |
| 10.8 | 90 | 5 | | | | 5 | | |
| 10.0 | 80 | 2 | 6 | 2 | 5 | 1 | 4 | |
| 1.8 | 80 | | 5 | | | | 15 | |
| 2.6 | 84 | | | 11 | | | 5 | |
| 3.3 | 80 | 4 | | | 10 | | | 6 |
| 12.0 | 90 | | | | 7 | 3 | | |
| 5.4 | 69 | 2 | 20 | 2 | 1 | | 3 | 3 |
| 6.0 | 91 | | | 4 | | | 5 | |

TABLE B

| Dye | Water | PG | DEG | NMP | TBT | BDL | PI2 |
|---|---|---|---|---|---|---|---|
| 3.0 | 80 | 20 | | | | | |
| 9.0 | 90 | | 5 | | | | 5 |
| 1.5 | 85 | 5 | 5 | | 5 | | |
| 2.5 | 90 | | 6 | 4 | | | |
| 3.1 | 82 | 4 | 8 | | | | 6 |
| 0.9 | 85 | | 10 | | | 5 | |
| 8.0 | 90 | | 5 | 5 | | | |
| 4.0 | 70 | | 10 | 4 | | 5 | 11 |
| 2.2 | 75 | 10 | 10 | 3 | | 2 | |
| 10.0 | 91 | | | 9 | | | |
| 9.0 | 76 | | 9 | 7 | 3 | 5 | |
| 5.0 | 78 | 5 | 11 | | | 6 | |
| 5.4 | 86 | | | 7 | 7 | | |
| 2.1 | 70 | 5 | 10 | 5 | 5 | 5 | |
| 2.0 | 90 | | 10 | | | | |
| 2 | 88 | | 12 | | | | |
| 5 | 78 | | | 5 | | 7 | 10 |
| 8 | 70 | 2 | 20 | 8 | | | |
| 10 | 80 | 10 | 10 | | | | |
| 10 | 80 | | 20 | | | | |

1. A compound of Formula (1) and salts thereof: 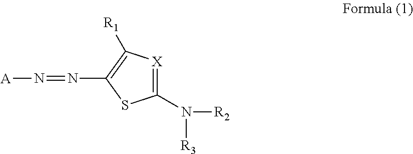
wherein:
A is optionally substituted heterocyclyl;
X is N or C—CN;
R¹ is H or a substituent;
R² and R³ are independently H, optionally substituted alkyl, optionally substituted aryl, optionally substituted heterocyclyl or —SO₂R⁴, wherein R⁴ is optionally substituted alkyl, optionally substituted aryl or optionally substituted heterocyclyl; and
provided that the compound of Formula (1) has attached, either directly or through a substituent, at least one ionic water solubilising group selected from the group consisting of CO₂H, COSH, SO₃H and PO₃H₂.

2. A compound of Formula (1) and salts thereof as claimed in claim 1 wherein A is selected from the group consisting of: optionally substituted pyrrolyl, optionally substituted benzothiazole, optionally substituted pyrazolyl, optionally substituted imidazolyl, optionally substituted triazolyl, optionally substituted thiazolyl, optionally substituted thiadiazolyl, optionally substituted pyridyl, optionally substituted pyrimidyl, optionally substituted pyrazinyl and optionally substituted isothiazolyl.

3. A compound of Formula (1) and salts thereof as claimed in claim 1 wherein A is optionally substituted pyrazolyl or optionally substituted isothiazolyl.

4. A compound of Formula (1) and salts thereof as claimed in claim 1 wherein X is N.

5. A compound of Formula (1) and salts thereof as claimed in claim 1 wherein R¹ is H, optionally substituted alkyl, optionally substituted aryl or optionally substituted heterocyclyl.

6. A compound of Formula (1) and salts thereof as claimed in claim 1 wherein R² and R³ independently are: H; optionally substituted C₁₋₄-alkyl carrying an ionic water solubilising group selected from the group consisting of CO₂H, COSH, SO₃H and PO₃H₂; or optionally substituted phenyl carrying an ionic water solubilising group selected from the group consisting of CO₂H, COSH, SO₃H and PO₃H₂.

7. A compound of Formula (1) and salts thereof as claimed in claim 1 wherein one of R² and R³ is not H.

8. A compound of Formula (1) and salts thereof as claimed in claim 1 wherein R⁴ is optionally substituted phenyl.

9. A compound of Formula (1) and salts thereof as claimed in claim 1 wherein the compulsory ionic water solubilising group is CO₂H or SO₃H.

10. A composition comprising a compound of Formula (1) and/or a salt thereof, as described in claim 1 and a liquid medium.

11. A composition as claimed in claim 10 which is ink suitable for use in an ink-jet printer.

12. A process for forming an image on a substrate comprising applying the ink suitable for use in an ink-jet printer, according to claim 11, thereto by means of an ink-jet printer.

13. A material printed with a compound as described in claim 1.

14. A material as claimed in claim 13 which is a print on a photographic quality paper.

15. An ink-jet printer cartridge comprising a chamber and the ink suitable for use in an ink-jet printer, according to claim 11, wherein the ink is in the chamber.
